(19) United States
(12) Patent Application Publication
(10) Pub. No.: US 2016/0147085 A1
(43) Pub. Date: May 26, 2016

(54) OPTICAL ARTICLE HAVING A RED RESIDUAL REFLECTION COLOUR

(71) Applicant: ESSILOR INTERNATIONAL (COMPAGNIE GENERALE D'OPTIQUE, Charenton le pont (FR)

(72) Inventors: Frédéric ARROUY, Charenton le Pont (FR); Francisco DE AYGUAVIVES, Charenton le Pont (FR); Ivan DIEGUEZ, Charenton le Pont (FR)

(73) Assignee: ESSILOR INTERNATIONAL (COMPAGNIE GENERALE D'OPTIQUE, Charenton le Pont (FR)

(21) Appl. No.: 14/902,978

(22) PCT Filed: Jul. 4, 2014
(86) PCT No.: PCT/FR2014/051735

§ 371 Date: Jan. 5, 2016

(30) Foreign Application Priority Data
Jul. 5, 2013 (FR) 1356668

(51) Int. Cl. G02C 7/10; G02B 1/11; G02B 1/18; G02B 5/28

(52) U.S. Cl. CPC G02C 7/107; G02B 5/285; G02B 1/11; G02B 1/18; G02C 7/104; G02C 2202/16

(57) ABSTRACT

The present invention relates to a transparent article comprising a substrate comprising at least one front face and one back face, at least one of these two main faces being coated with an interference coating having a reflection value in the visible Rᵥ lower than or equal to 97% and preferably lower than or equal to 50%, characterized in that said interference coating possesses a hue angle h and a chroma value C* able to render the present residual reflection a given perceived chromatic colour in the red.

The present invention generally relates to a transparent article, especially an optical article, such as an ophthalmic lens, comprising an interference stack having a perceived chromatic color of uniform residual reflection.

In particular, the invention relates to an article, such as an ophthalmic lens including two main faces, a front face and a back face, at least one of these two main faces comprising an interference stack, in particular an antireflection stack, the perceived chromatic color of the residual reflection of which is a uniform red hue.

It is standard to deposit on ophthalmic lenses antireflection stacks allowing the average reflection factor in the visible to be decreased.

This type of coating makes it possible to make the eyes of the wearer of the lenses more visible to an observer. Furthermore, it improves the comfort of the wearer especially by suppressing parasitic reflections, dazzle and improving the perception of contrasts.

Antireflection coatings most often have a residual color.

This residual color is perceived by the person facing the wearer of the lens.

Each commercially available antireflection ophthalmic lens sold under a given brand has a residual color that is specific thereto and each manufacturer must ensure its reproducibility, so that the perceived color is substantially identical from one lens to another, i.e. so that two manufactured lenses cannot be distinguished and their residual reflections are considered to be identical by an observer.

This residual color is generally located in the green domain, but other colors such as a yellow (gold) or violet color are also common.

However, certain residual colors, such as red, are more delicate and difficult to produce.

On the one hand, from a point of view of the design of a lens, it is indeed difficult to find an interference stack, especially an antireflection stack, the perception of the color in the visible of which appears as “red” to an observer. Existing antireflection coatings that have the aim of having such a perceived chromatic residual reflection color, rather appear with hues that are too orange, or too pink.

On the other hand, during the production of lenses in the production phase, the deposition conditions of the interference stack are subject to a certain variability. Specifically, the deposition conditions for example depend: on the type of substrate used, on the parameterization of the machine (e.g., programming of the temperature rise, parameterization of the electron gun, etc.) and/or its method of use, on a change of manufacturing machine (specifically the implementation parameters will possibly differ very slightly from one machine to another), or even the geographical zone (for example, a difference in humidity between two countries may affect the parameterization of the machine). These various variability factors may thus lead to non-negligible modifications in the final properties of the eyeglass lens, such as especially a colorimetric dispersion in the color of the interference stack that will generally extend from “orange” to “pink”, instead of red, from one lens to another. Perceived residual color is thus difficult to reproduce.

From the prior art, patent application WO 2007/080342 is known, which describes an ophthalmic lens comprising an at least partially tinted transparent substrate having a front face and a back face, the front face including a first antireflection coating and the back face including a second antireflection coating, the two coating residuals having a perceived chromatic residual reflection color.

In particular, the first antireflection coating possesses a light reflection factor Rv≦2.5%, a hue angle h measured in the CIE L*, a*, b* color system between 310° and 30°, thereby corresponding to a “pink” perceived residual reflection color, and a chroma C₁*≧15 and preferably C₁*≧17. According to one exemplary embodiment, this first antireflection coating, when it has a “pink” perceived residual reflection color, possesses a hue angle h of 355° and a chroma C₁* of 18.5.

However, this document does not describe the obtainment of an antireflection coating having a “red” perceived chromatic residual reflection color.

There is therefore a need to provide an ophthalmic lens, treated with an interference stack, such as an antireflection stack, having a perceived residual reflection color that is “red” and uniform right over the lens, especially on curved surfaces, while being easily reproducible.

The aim of the present invention is thus to provide a new article, in particular an optical article, that avoids all or some of the aforementioned drawbacks.

In the rest of the description, unless otherwise specified, the indication of a range of values “from X to Y”, in the present invention, will be understood as including the values X and Y.

For this purpose, the subject of the present invention is a transparent article comprising a substrate comprising at least one front face and one back face, at least one of these two main faces being coated with an interference coating having a residual reflection and having a reflectance in the visible Rᵥ lower than or equal to 97% and preferably 50%, characterized in that said interference coating possesses a hue angle h and a chroma C* (in the CIE L*, a*, b* color system) that are able to give the residual reflection a given chromatic color perceived in the red. According to the invention, the front face of an article or a substrate is the face that, during use, is the furthest from the eye of the user. This is generally a convex face. Conversely, the back face of the article or substrate is that which, during use, is the closest to the eye of the user. This is generally a concave face.

For example, employing an interference coating possessing, for a given perceived residual reflection color, a hue angle h of 0° to 40° and a chroma C* higher than or equal to 20 (and preferably lower than or equal to 50), makes it possible to obtain an optical article having an interference coating the perception of the color in the visible of which appears red to an observer and no longer orange or pink as was the case in the prior art. Thus, the Applicant has succeeded in overcoming the difficulty in designing such a lens.

The perceived color of this red residual reflection is moreover uniform right over the surface of the article on which the interference coating according to the invention is deposited, even on curved surfaces. The term “uniform” is understood to mean that the intensity and/or the shade of the color of the residual reflection does not vary or varies negligibly over all of the interference coating of the transparent article (same or similar perceived residual reflection color).

Furthermore, it also turns out that production of the article on an industrial scale does not modify the red perceived chromatic residual reflection color despite the variability factors inherent to the deposition conditions of the interference coating on the article (good industrial reliability). Without wanting to be tied to any one theory, it would appear that the interference coating has a residual reflection color that is sufficiently saturated in color to stabilize the hue angle of the coating between 0° and 40° during the deposition of the interference coating on the article.

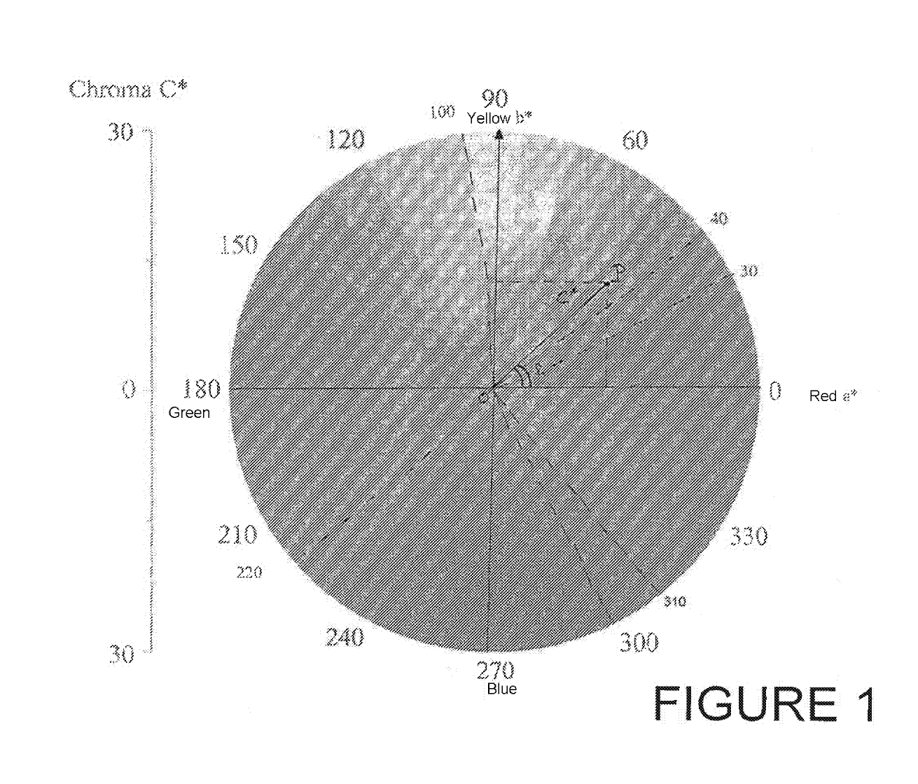

Throughout this patent application, the color coordinates (chroma C* and hue angle h) are defined in the CIE L*a*b* 1976 system for the 10° Standard Observer and Illuminant D65, at an angle of incidence of 15°. The CIE L*a*b* color system is illustrated in FIG. 1. The Standard Observer is also defined in the CIE L*a*b* system.

With reference to FIG. 1, a color according to the CIE system is defined by a point P of coordinates a* (measuring the variation from red to green) and b* (measuring the variation from yellow to blue), a hue angle h (or shade) that is the angle of OP to the axis of the a*, and a chroma (or saturation) C* that is equal to the length of the segment OP.

The hue angle h represents the sensation of color and the chroma C* expresses the sensation of chromatic purity, i.e. the position on a scale that ranges from black to “achromatic” white (devoid of any tonality) to the saturated “monochromatic” color of completely pure tonality.

The expression “perceived chromatic color” is understood to mean a color perceived as possessing a chromatic tonality.

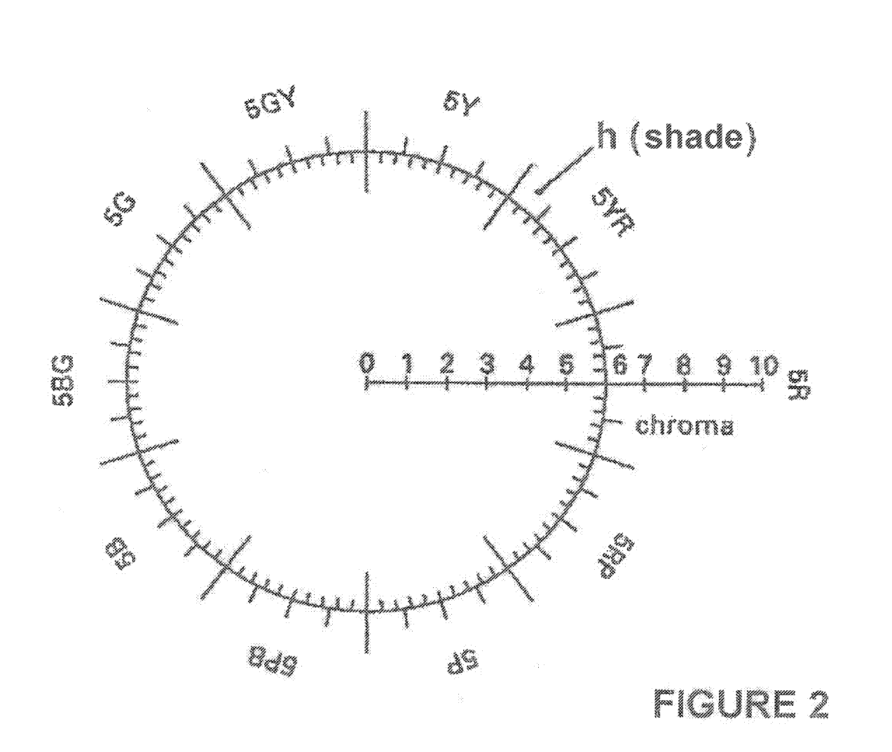

“Chromatic tonality” (or hue) is the attribute of the sensation in the visible that has given rise to color denominations such as: blue, green, yellow, red, purple, etc. An example of colors perceived as being the same chromatic tonality is given by the Munsell Atlas, which is illustrated in FIG. 2. The Munsell Atlas defines ten (10) sectors of principle hues (of 32°) constructed from the blue (B), green (G), yellow (Y), red (R) and purple (P) as shown in FIG. 2.

In the context of the present invention, the expression “given red perceived chromatic residual reflection color” designates a perceived chromatic color having a given red chromatic tonality.

The perceived chromatic color is judged according to the following observation protocol:

The optical articles are placed in a standardized lightbox (1000 lux of illumination, standardized source reproducing the Illuminant D65). The bottom of the box is a neutral grey of lightness L*=50 (CIE recommendation). The optical articles are observed at a distance of 50 cm by an emmetropic observer at an angle of observation of 15°.

That face of the article which is to be examined is positioned closest to the eye of the observer.

In the case of an ophthalmic lens, if the color in reflection of an interference stack of the lens located on its front face, i.e. the convex face, is observed, the latter will be oriented so that it is the face closest to the observer.

If the color in reflection of an interference stack of the lens located on its back face, i.e. the concave face, is observed, the latter will be oriented so that it is the face closest to the observer.

The preferred values of hue angle h are 0° to 40°. On account of fluctuations inherent to the deposition process during the manufacture of the optical article, these values of h especially allow a good reproducibility to be obtained for the interference coating.

According to a first embodiment, the values of hue angle h may be the following: from 5° to 40°, preferably from 5 to 35°, more preferably from 10 to 30°, especially from 15° to 30° and typically from 15 to 25°. According to this embodiment, h may not comprise the value 30° and/or be, for example, strictly lower than 30°.

According to a second embodiment, the values of hue angle h are located from 30° to 40°. According to this embodiment, h may in particular be strictly higher than 30° (namely, possible exclusion of the value h=30°.

Advantageously, the chroma C* of the interference coating is higher than or equal to 30 and preferably is strictly higher than 30.

Generally, the chroma C* of the interference coating is lower than or equal to 50, better still lower than or equal to 45 and may range from 30 to 50, preferably 30 to 45, better still from 35 to 45 and in particular from 39 to 45.

The interference coating is also characterized by a light reflection factor in the visible Rᵥ. This factor Rᵥ takes account of the relative spectral luminous efficacy function of the eye. The light reflection factor Rᵥ is such as defined in standard ISO 13666:1998, and measured according to standard ISO 8980-4 (2000 Jun. 1) at an angle of incidence of 15°. It is a question of the weighted mean of the spectral reflectivity over the entirety of the visible light spectrum comprised between 380 nm and 780 nm.

This reflection factor in the visible Rᵥ is according to the invention lower than or equal to 97% and preferably lower than or equal to 50%.

By reflectance in the visible Rᵥ lower than or equal to 97%, what is meant is a value lower than or equal to 97%, 96%, 95%, 90%, 85%, 80%, 75%, 70%, 65%, 60%, 55%, 50%, 45%, 40%, 35%, 30%, 25%, 20%, 15%, 10%, 8%, 7%, 6%, 5%, 4%, 3%, 2.5%, 2% and 1.5%.

In particular, Rᵥ may have the following values: Rv≦40%, preferably Rv≦30%, in particular Rv≦20% and typically Rv≦10%.

When the reflection factor in the visible Rᵥ<2.5%, the interference coating is said to be an antireflection (AR) coating; when the reflection factor in the visible Rᵥ≧2.5%, the interference coating is said to be a “mirror effect” coating.

Thus, according to a first embodiment, the coating is a mirror effect coating and Rv has a value preferably ranging from 4% to 10%. Generally, Rv has a value lower than or equal to 4% and especially Rᵥ is lower than or equal to 3%.

According to a second embodiment, the reflection factor in the visible respects the following relationship: 2% ≦Rᵥ≦2.5%.

Preferably, the interference coating according to the invention is an antireflection (AR) coating and Rᵥ<2.5%.

As is well known, the preferably antireflection (AR) interference coating recommended for the present invention generally comprises a stack of alternated layers of high refractive index and of low refractive index.

By high refractive index layer (called an HI layer), what is meant is a layer having a refractive index higher than or equal to 1.50, preferably higher than or equal to 1.60, better still higher than or equal to 1.8, and in particular from 1.8 to 2.2; and by low refractive index layer (called a BI layer), what is meant is a layer having a refractive index lower than 1.50 and preferably lower than 1.48. Unless otherwise indicated, all the refractive indices indicated in the present patent application are expressed for a reference wavelength of 550 nm and at a temperature of 25° C.

Generally, the high refractive index HI layers comprise, nonlimitingly, one or more metal oxides such as TiO₂, PrTiO₃, LaTiO₃, ZrO₂, Ta₂O₅, Y₂O₃, Ce₂O₃, La₂O₃, Dy₂O₅, Nd₂O₅, HfO₂, Sc₂O₃, Pr₂O₃ or Al₂O₃, and Si₃N₄, or a mixture thereof, preferably ZrO₂, TiO₂, or Pr₂O₃, and in particular ZrO₂. The high refractive index layers may optionally comprise low refractive index materials such as SiO₂. Obviously, the one or more mixtures of these materials are such that the resulting layer has a refractive index such as defined above, namely higher than or equal to 1.50.

The low refractive index LI layers are well known and for example comprise nonlimitingly SiO₂, SiOₓ where 1≦x<2, MgF₂, ZrF₄, Al₂O₃, AlF₃, chiolite (Na₃Al₃F₁₄), cryolite (Na₃[AlF₆]), or a mixture thereof, preferably SiO₂ or SiO₂ doped with Al₂O₃ which allows the critical temperature of the stack to be increased. In particular, the low refractive index layer comprises SiO₂. Also, the one or more mixtures of these materials are such that the resulting layer has a refractive index such as defined above, namely lower than 1.50.

When the mixture SiO₂/Al₂O₃ is used, the low refractive index layer preferably contains from 1 to 10%, in particular from 1 to 8% and even better still from 1 to 5% by weight Al₂O₃ relative to the total weight of silica and alumina in this layer. Specifically, too high a proportion of alumina may be prejudicial to the adhesion of the antireflection coating.

For example, layers of SiO₂ doped with 4% or less Al₂O₃ by weight, or a layer of SiO₂ doped with 8% Al₂O₃ may be employed. Commercially available SiO₂/Al₂O₃ mixtures may be used, such as the LIMA® mixture sold by Umicore Materials AG (refractive index comprised between 1.48 and 1.50) or the substance L5® sold by Merck KGaA (refractive index equal to 1.48 for a wavelength of 500 nm).

Typically, the one or more low index layers consist of SiO₂ and the one or more high refractive index layers consist of ZrO₂.

Preferably, the antireflection coating according to the invention comprises the same number of high and low refractive index layers.

Generally, the antireflection coating comprises from 4 to 6 layers, typically for layers, without taking into account an optional sublayer.

In one particularly preferred embodiment, the antireflection coating comprises, starting from the face of the substrate, a first high refractive index layer made of ZrO₂, a second low refractive index layer made of SiO₂, a third high refractive index layer made of ZrO₂ and a fourth low refractive index layer made of SiO₂.

For example, the interference coating comprises a stack from the substrate of at least four successive layers having the following physical thicknesses:

from 100 to 120 nm for the high refractive index layer, such as ZrO₂;

from 110 to 140 nm for the low refractive index layer, such as SiO₂;

from 75 to 95 nm for the high refractive index layer, such as ZrO₂; and

from 55 to 77 nm for the low refractive index layer, such as SiO₂.

In general, the ratio (total physical thickness of the low refractive index layers)/(total physical thickness of the high refractive index layers) of the layers of the antireflection coating varies from 0.6 to 1.2.

Unless otherwise indicated, all the layer thicknesses disclosed in the present application are physical thicknesses, and not optical thicknesses.

The materials used to produce a mirror effect interference coating may be the same as those mentioned above for the antireflection coating. The thicknesses of the layers of the mirror effect coating are however different from those of an antireflection coating and it will be possible for a person skilled in the art to adapt them.

Again preferably, the interference coating, such as the antireflection coating, is deposited on a bonding sublayer, for example made of SiO₂, between the stack of alternated high and low refractive index layers and the face of the substrate.

This bonding sublayer in general has a thickness from 50 to 250 nm.

The layers of the interference coating such as an antireflection coating may be deposited by any known means such as by evaporation, optionally assisted by ion beams, by ion beam sputtering, by cathode sputtering, or by plasma enhanced chemical vapour deposition or by evaporation in a vacuum chamber.

The layers of the interference coatings, such as an antireflection coating, are preferably deposited by high pressure cathode sputtering.

The substrate of the ophthalmic lens according to the invention is preferably made of organic glass, for example of a thermoplastic or thermoset.

Regarding thermoplastics suitable for the substrates, mention may be made of (meth)acrylic (co)polymers, in particular polymethyl methacrylate (PMMA), thio(meth)acrylic (co)polymers, polyvinyl butyral (PVB), polycarbonates (PC), polyurethanes (PU), polythiourethanes, polyol(allyl carbonate) (co)polymers, thermoplastic ethylene/vinyl acetate copolymers, polyesters such as polyethylene terephthalate (PET) or polybutylene terephthalate (PBT), polyepisulfides, polyepoxides, polycarbonate/polyester copolymers, cyclic olefin copolymers such as ethylene/norbornene or ethylene/cyclopentadiene copolymers and their blends.

The term “(co)polymer” is understood to mean a copolymer or a homopolymer. The term “(meth)acrylate” is understood to mean an acrylate or a methacrylate. The term “polycarbonate (PC)” is understood in the context of the present invention to mean both homopolycarbonates and copolycarbonates and sequenced copolycarbonates.

Particularly recommended substrates are substrates obtained by (co)polymerization of diethyleneglycol bis allylcarbonate, sold, for example, under the commercial denomination CR39® by PPG Industries (ESSILOR ORMA® lenses), or by polymerization of thio(meth)acrylic monomers, such as those described in French patent application FR 2734827. The substrates may be obtained by polymerization of blends of the above monomers, or may even comprise blends of these polymers and (co)polymers.

Other preferred substrates are the polycarbonates.

The one or more interference coatings according to the invention, such as an antireflection coating, having a red perceived residual reflection color may be deposited on a bare substrate, i.e. a substrate the main faces of which comprise no coating, or on already coated substrates, i.e. substrates the main faces of which comprise one or more functional coatings.

Specifically, a coating that is “on” the substrate or that has been deposited “on” the substrate is defined as a coating that:

(i) is positioned above one of the main faces of the bare substrate;

(ii) does not necessarily make contact with the substrate, i.e. one or more intermediate, generally functional, coatings may be placed between the bare substrate and the coating in question; and

(iii) does not necessarily completely cover the main face of the substrate.

Functional coatings are well known and comprise, by way of example, a primer for adhesion and/or shock resistance and/or an abrasion resistant coating and/or a polarization coating and/or a photochromic coating.

Among shock resistant primers, mention may be made of coatings based on methacrylate and based on polyurethane.

Shock resistant coatings based on (meth)acrylate are, inter alia, described in patent U.S. Pat. No.5,015,523, whereas coatings of cross-linked thermoplastic polyurethane resin are described, inter alia, in the Japanese patents 63-141001 and 63-87223, and in EP 0404111 and U.S. Pat. No. 5,316,791.

Preferred shock resistant primer coatings are coatings based on a latex composition such as a poly(meth)acrylic latex, a polyurethane latex or a polyester latex.

Among preferred shock resistant primer coatings based on (meth)acrylate, mention may be made of materials based on polyethyleneglycol(meth)acrylate such as, for example, tetraethyleneglycoldiacrylate, polyethyleneglycol(200)diacrylate, polyethyleneglycol(400)diacrylate, polyethyleneglycol(600)di(meth)acrylate, and the (meth)acrylateurethanes, or a mixture thereof.

Among preferred shock resistant primer coating compositions, mention may also be made of the acrylic latexes sold under the denomination acrylic latex A-639 by ZENECA and the polyurethane latexes sold under the designations W-240 and W-234 by BAXENDEN.

Among preferred anti-abrasion coatings, mention may be made of those obtained by curing a composition comprising epoxyalkoxysilanes or a hydrolyzate thereof with an acid and a curing agent.

Examples of such compositions are given in patents U.S. Pat. No. 4,211,823 and U.S. Pat. No. 5,015,523 and in international patent application WO 94/10230.

Preferred anti-abrasion coating compositions are those comprising by way of main constituents an epoxyalkoxysilane such as for example γ-glycidoxypropyltrimethoxylsilane (GLYMO® sold by Degussa Huls) and a dialkyldialkoxysilane such as, for example, dimethyldiethoxysilane, colloidal silica and a catalytic quantity of a curing catalyst such as an aluminum acetylacetonate or a hydrolyzate thereof, the rest of the composition essentially being composed of solvents conventionally used in their formation.

The compositions of polarization and/or photochromic coatings are well known in the art.

For example, photochromic coatings may include photochemical agents chosen from the spirooxazines and naphthopyrans. Such coatings are described inter-alia in patents U.S. Pat. No. 6,281,366; EP 0772798; U.S. Pat. No. 6,019,914 and U.S. Pat. No. 7,186,359.

The substrates may be uncolored substrates or substrates colored by introducing pigments into their bulk, into a coating deposited on the substrate or by any other means (imbibition, etc.). Preferably, the substrates are uncolored.

In one embodiment, the substrates are themselves colored with a red pigment reinforcing the effect of the interference coating according to the invention.

The one or more interference coatings, which are preferably antireflection coatings, may themselves be coated with an anti-smudge coating, such as a hydrophobic and/or oleophobic coating. These anti-smudge coatings are also well known in the art and are conventionally based on fluorosilicone or fluorosilazane, i.e. silicones or silazanes including fluorine-containing groups.

An example of such a preferred material is the product sold by SHIN-ETSU under the designation KP 801 M®.

One of the Optool DSX® materials sold by Daikin may also be used.

According to one feature of the invention, the interference coating according to the invention having a red perceived residual reflection color is, preferably, placed only on the front face of the article.

According to another feature of the invention, both main faces of the article, such as the front face and the back face, may include the interference coating according to the invention such as described above.

Generally, the article is an optical article, such as an ophthalmic lens.

The ophthalmic lens according to the invention is preferably a spectacle glass.

The following nonlimiting examples illustrate the present invention.

### EXAMPLES

By way of example, the properties of two lenses according to the invention having on their front main face an antireflection AR coating having a red residual reflection color, are given below in table 1.

The values of h, C* and Rv are given in the CIE 1976 LAB color space with a 10° Observer and Illuminant D65.

TABLE 1

| | Stack of the AR layers | | | | |
|---|---|---|---|---|---|
| Examples | (physical thickness in nm) | | | | |
| lenses | starting from the substrate | | h | C* | Rv(%) |
| Ex. 1 | ZrO₂ | (106.9) | 0° | 39.8 | 2.19 |
| | SiO₂ | (130.8) | | | |
| | ZrO₂ | (83.5) | | | |
| | SiO₂ | (64.5) | | | |
| Ex. 2 | ZrO₂ | (113.4) | 15° | 39.4 | 2.16 |
| | SiO₂ | (119.9) | | | |
| | ZrO₂ | (87.4) | | | |
| | SiO₂ | (63.7) | | | |

The refractive index of SiO₂ is 1.473 and that of ZrO₂ is 2 at 550 nm and at 25° C.

The substrate used was an ORMA® lens made of organic glass consisting of a diethyleneglycol bis allylcarbonate polymer (CR39®), of a thickness at the centre of 2 mm.

The anti-abrasion coating is such as described in example 3 of patent EP614957. It was obtained by introducing drop by drop 80.5 parts of 0.1N hydrochloric acid into a solution containing 224 parts GLYMO and 120 parts DMDES. The hydrolyzed solution was stirred for 24 hours at room temperature then 718 parts of 30% colloidal silica in methanol, 15 parts aluminum acetylacetonate and 44 parts ethyl cellosolve were added. A small quantity of a surfactant was added. The theoretical solid content (TSC) of the composition contained about 13% solid material originating from the hydrolyzed DMDES.

Each substrate was coated with the anti-abrasion coating composition by dip coating, then subjected to a pre-bake of 15 minutes at 60° C. They were then baked for 3 hours.

The thickness of the anti-abrasion coating generally varied from 2 to 4 microns.

Next, for each lens, the anti-abrasion coating was coated, by evaporation in a vacuum chamber, with an antireflection coating (Rv<2.5%) comprising a stack, from the substrate, of high refractive index layers (ZrO₂) and low refractive index layers (SiO₂). Depending on the lens (example 1 or 2), and as is illustrated in table 1, the thickness of each high and low refractive index layer was different. It will be noted that variations in the thicknesses of these layers, which may conventionally arise during manufacture of the stacks, caused only small variations in the values of h, of chroma C* and of Rv.

Results:

The lenses 1 and 2 were then observed according to the observation protocol described above.

They were perceived to have a red residual reflection when the observer was located facing the lens.

Although the invention has been described with regard to a plurality of particular embodiments, it is of course obvious that it is in no way limited thereto and that it comprises all techniques equivalent to the means described and their combinations if these are encompassed within the scope of the invention.

1-15. (canceled)

16. A transparent article comprising a substrate comprising at least one front face and one back face, at least one of these two main faces being coated with an interference coating having a residual reflection and having a reflectance in the visible Rᵥ lower than or equal to 97%, wherein said interference coating possesses a hue angle h and a chroma C* that are able to give the residual reflection a given chromatic color perceived in the red.

17. The article as claimed in claim 16, wherein the hue angle h ranges from 0° to 40° and the chroma C* is higher than or equal to 20.

18. The article as claimed in claim 17, wherein the chroma C* is lower than or equal to 50.

19. The article as claimed in claim 18, wherein the chroma C* is higher than or equal to 30.

20. The article as claimed in claim 18, wherein the chroma C* is strictly higher than 30.

21. The article as claimed in claim 16 or 17, wherein the hue angle ranges from 5° to 40°.

22. The article as claimed in claim 21, wherein the hue angle ranges from 5° to 35°.

23. The article as claimed claim 16 or 17, wherein the reflectance in the visible Rᵥ≦30%.

24. The article as claimed in claim 23, wherein the reflectance in the visible Rᵥ≦10%.

25. The article as claimed in claim 16 or 17, wherein the interference coating is an antireflection (AR) coating and has a reflectance Rᵥ<2.5%.

26. The article as claimed in claim 16 or 17 , wherein the interference coating comprises a stack of alternated layers of high refractive index higher than or equal to 1.50, and of low refractive index lower than 1.50.

27. The article as claimed in claim 26, wherein the one or more low index layers consist of SiO₂ and the one or more high refractive index layers consist of ZrO₂.

28. The article as claimed in claim 26, wherein the interference coating comprises a stack from the substrate of at least four layers having the following physical thicknesses:
from 100 to 120 nm for the high refractive index layer;
from 110 to 140 nm for the low refractive index layer;
from 75 to 95 nm for the high refractive index layer; and
from 55 to 77 nm for the low refractive index layer.

29. The article as claimed in claim 16 or 17, wherein at least one of the two main faces of the substrate is already coated with one or more functional coatings chosen from: a primer layer for adhesion and/or shock resistance, an abrasion resistant coating, and/or a polarization coating, a photochromic coating.

30. The article as claimed in claim 16 or 17, wherein the interference coating is coated with an anti-smudge coating.

31. The article as claimed in claim 16 or 17, wherein the interference coating is placed only on the front face of the article.

32. The article as claimed in claim 31, wherein the interference coating is placed on the front face and on the back face of the article.

33. The article as claimed in claim 16 or 17, wherein the article is an optical article.

34. The article as claimed in claim 33, wherein the article is an ophthalmic lens.

35. The article as claimed in claim 16 or 17, wherein said interference coating has a reflectance in the visible Rᵥ lower than or equal to 50%.
